(19) United States
(12) Patent Application Publication
(10) Pub. No.: US 2016/0068204 A1
(43) Pub. Date: Mar. 10, 2016

(54) Sealing Lip and Seal Assembly for Track Pin Joint Assemblies

(71) Applicant: Caterpillar Inc., Peoria, IL (US)

(72) Inventor: Chandrasen Rameshlal Rathod, Peoria, IL (US)

(21) Appl. No.: 14/681,749

(22) Filed: Apr. 8, 2015

Related U.S. Application Data
(60) Provisional application No. 62/048,093, filed on Sep. 9, 2014.

(51) Int. Cl. B62D 55/088; F16J 15/32; F16J 15/00

(52) U.S. Cl. CPC B62D 55/0887; F16J 15/002; F16J 15/3204

(57) ABSTRACT

A seal assembly for use in sealing a joint having a first member pivotable about a rotational axis relative to a second member. The seal assembly may include a load ring engaged by the first member, a sealing lip engaging a sealing surface of the second member, and seal ring there between. The sealing lip may have a sealing lip body with a first convex rounded engagement portion of a second member engagement surface positioned to engage the sealing surface when the seal assembly is assembled in the axially-extending seal cavity between the first member and the second member. The second member engagement surface may include additional convex engagement portions, and the sealing lip may include a sealing lip flange extending radially outwardly from the sealing lip body and disposed proximate the sealing surface after assembly.

### TECHNICAL FIELD

The present disclosure relates generally to undercarriage for track-type machines and, more particularly, to a seal assembly including a sealing lip for use in a track pin joint assembly of such undercarriage.

### BACKGROUND

Track-type machines are in widespread use in construction, mining, forestry, and other similar industries. The undercarriage of such track-type machines utilizes track assemblies, rather than wheels, to provide ground-engaging propulsion. Such track assemblies may be preferred in environments where creating sufficient traction is problematic, such as the environments identified above. Specifically, rather than rolling across a work surface on wheels, track-type machines utilize one or more track assemblies that include an endless loop of coupled track links defining exterior surfaces, which support ground-engaging track shoes, and interior surfaces that travel about one or more rotatable track-engaging elements, such as, drive sprockets, idlers, tensioners, and rollers, for example.

Typical track chain assembly designs include a series of alternating track pins and chain links forming an endless loop. Each track pin connects an adjacent pair of chain links to allow relative rotation of the joined chain links about a longitudinal axis of the track pin. The track chain assembly may include a pair of parallel endless chain link loops connected by the track pins, with bushings rotatably positioned on the track pins between the parallel track link loops to maintain their separation. Such track chain assemblies can operate in extremely adverse environments in which track joints may be exposed to various abrasive mixtures of water, dirt, sand, rock or other mineral or chemical elements.

Track seals are disposed between the moving components of a track chain assembly of a tracked undercarriage in order to seal the track chain against dirt, mud, and debris while retaining lubricants in the track chain assembly. The failure of a seal within a track chain can accelerate wear and cause early failure of a portion of the track chain and require premature replacement. A common type of seal used in track chain assemblies is referred to as a “can” seal assembly. A can seal assembly often includes a sealing lip supported by a seal ring or “can” and a load ring engaging the can. A surface defining a seal cavity can interact with the load ring to apply a force to the can and the sealing lip. The sealing lip engages a sealing surface of a component adjacent to the component having the seal cavity. Together, the can seal assembly, the surface defining the seal cavity, and the sealing surface of the adjacent component provide a sealed interface to retain lubricant within the assembly and to protect against dirt, mud, abrasive materials, debris and other contaminants. Examples of such can seals are shown and described in U.S. Pat. No. 6,678,696 and U.S. Pat. Appl. Publ. Nos. 2012/02678559 and 2013/0002010.

One cause of failure in track chain assemblies having can-type seal assemblies is the formation of grooves in the sealing surface over time as the sealing lip moves relative to the sealing surface both radial and axial directions. Due to tolerances and play within the track pin, the sealing lip rubs against the sealing surface in the radial direction. Over time, material wears away from the rubbed portion of the sealing surface to create a groove therein, and may wear away from the portion of the sealing lip engaging the sealing surface. As the groove forms and deepens, the seal force between the lip and surface weaken, thereby making it easier for the seal to be compromised. Wear and formation of the groove may increase as sand, dirt and other abrasive materials penetrate the interface between the sealing lip and the sealing surface. Additionally, axial movement increases over time as parts wear and allow more play between the components that further weakens the seal strength when the adjacent components move away from each other. In view of this, a need exists for reducing wear and penetration of abrasive materials in can-type seal assemblies in track pins of track chain assemblies.

### SUMMARY OF THE DISCLOSURE

In one aspect of the present disclosure, a seal assembly for use in sealing a joint is disclosed. The joint may have a first member pivotable about a rotational axis relative to a second member thereof, with the first member including a first load ring engagement surface defining an axially-extending seal cavity about the rotational axis, and the second member including a sealing surface. The seal assembly may include a load ring, and seal ring and a sealing lip. The load ring may have a first member engagement surface that is complimentary to the first load ring engagement surface, and a seal ring engagement surface. The seal ring may have an axial flange extending parallel to the rotational axis, a radial flange extending perpendicular to the rotational axis, a second load ring engagement surface, and a concave groove in the radial flange. The sealing lip may have a sealing lip body with a convex seal ring engagement surface with a complimentary shape to the concave groove for receipt therein, and a second member engagement surface having a first convex rounded engagement portion positioned to engage the sealing surface of the second member when the seal assembly is assembled in the axially-extending seal cavity between the first member and the second member.

In another aspect of the present disclosure, a sealing lip for a seal assembly is disclosed. The seal assembly may be used to seal a joint having a first member pivotable about a rotational axis relative to a second member thereof, with the first member including a first load ring engagement surface defining an axially-extending seal cavity about the rotational axis, and the second member including a sealing surface, and wherein the seal assembly includes a load ring having a first member engagement surface that is complimentary to the first load ring engagement surface, and a seal ring engagement surface, and a seal ring having an axial flange extending parallel to the rotational axis, a radial flange extending perpendicular to the rotational axis, a second load ring engagement surface, and a concave groove in the radial flange. The sealing lip may include a sealing lip body and a sealing lip flange. The sealing lip body having an inward end, an oppositely disposed outward end positioned radially outward of the inward end, a convex seal ring engagement surface with a complimentary shape to the concave groove for receipt therein, and a second member engagement surface having a first engagement portion positioned to engage the sealing surface of the second member when the seal assembly is assembled in the axially-extending seal cavity between the first member and the second member. The sealing lip flange may extend radially outwardly from an outward end of the sealing lip body and have a sealing side radial surface positioned axially closer to the convex seal ring engagement surface than the first engagement portion of the second member engagement surface. The sealing side radial surface may be disposed adjacent to and facing the sealing surface when the seal assembly is assembled in the axially-extending seal cavity between the first member and the second member.

In a further aspect of the present disclosure, a seal assembly for sealing a joint is disclosed. The joint may have a first member pivotable about a rotational axis relative to a second member thereof, with the first member including a first load ring engagement surface defining an axially-extending seal cavity about the rotational axis, and the second member including a sealing surface. The seal assembly may include a load ring, a seal ring and a sealing lip. The load ring may have a first member engagement surface that is complimentary to the first load ring engagement surface, and a seal ring engagement surface. The seal ring may have an axial flange extending parallel to the rotational axis, a radial flange extending perpendicular to the rotational axis, a second load ring engagement surface, and a concave groove in the radial flange. The sealing lip may have a sealing lip body with a convex seal ring engagement surface with a complimentary shape to the concave groove for receipt therein, and a second member engagement surface having a first engagement portion positioned to engage the sealing surface of the second member when the seal assembly is assembled in the axially-extending seal cavity between the first member and the second member, and a second engagement portion that is convex and rounded, and positioned adjacent the first engagement portion and radially closer to the rotational axis and axially closer to the convex seal ring engagement surface.

Additional aspects are defined by the claims of this patent.

### BRIEF DESCRIPTION OF THE DRAWINGS

FIG. 1 is a side elevational view of an exemplary track-type machine in which seal assemblies in accordance with the present disclosure may be implemented;

FIG. 2 is an isometric view of a portion of the track chain assembly of the track-type machine of FIG. 1;

FIG. 3 is a partial cross-sectional view of the portion of the track chain assembly of FIG. 2 with a track pin cartridge shown in cross-section;

FIG. 4 is an enlarged cross-sectional view of one end of the track pin cartridge of FIG. 3;

FIG. 5 is a cross-sectional view of a seal assembly of the track pin cartridge of FIG. 3 shown in an uninstalled state in comparison to a surface of a seal cavity and a sealing surface between which the seal assembly is installed;

FIG. 6 is a cross-sectional view of an embodiment of a sealing lip of the seal assembly of FIG. 5;

FIG. 7 is a cross-sectional view of the seal assembly of FIG. 5 shown with the sealing lip compressed against the sealing surface;

FIG. 8 is a cross-sectional view of an alternative embodiment of a sealing lip of the seal assembly of FIG. 5;

FIG. 9 is a cross-sectional view of a further alternative embodiment of a sealing lip of the seal assembly of FIG. 5;

FIG. 10 is a cross-sectional view of the seal assembly of FIG. 5 shown with the sealing lip of FIG. 9 compressed against the sealing surface; and

FIG. 11 is a cross-sectional view of the sealing lip of FIG. 6 with relevant design dimensions indicated.

### DETAILED DESCRIPTION

Although the following text sets forth a detailed description of numerous different embodiments, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

It should also be understood that, unless a term is expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to herein in a manner consistent with a single meaning, that is done for sake of clarity only so as to not confuse the reader, and it is not intended that such claim term be limited, by implication or otherwise, to that single meaning

The present disclosure provides a seal assembly for a track pin cartridge assembly of an undercarriage of a track-type machine. Examples of such machines include machines used for construction, mining, forestry, and other similar industries. In some embodiments, the machine can be a dozer, loader, or excavator, or any other on-highway or off-highway vehicle having a track-type undercarriage with first and second track chain assemblies disposed on opposing sides of the undercarriage. The track assemblies can be adapted to engage the ground or other surface to propel the track-type machine over the surface.

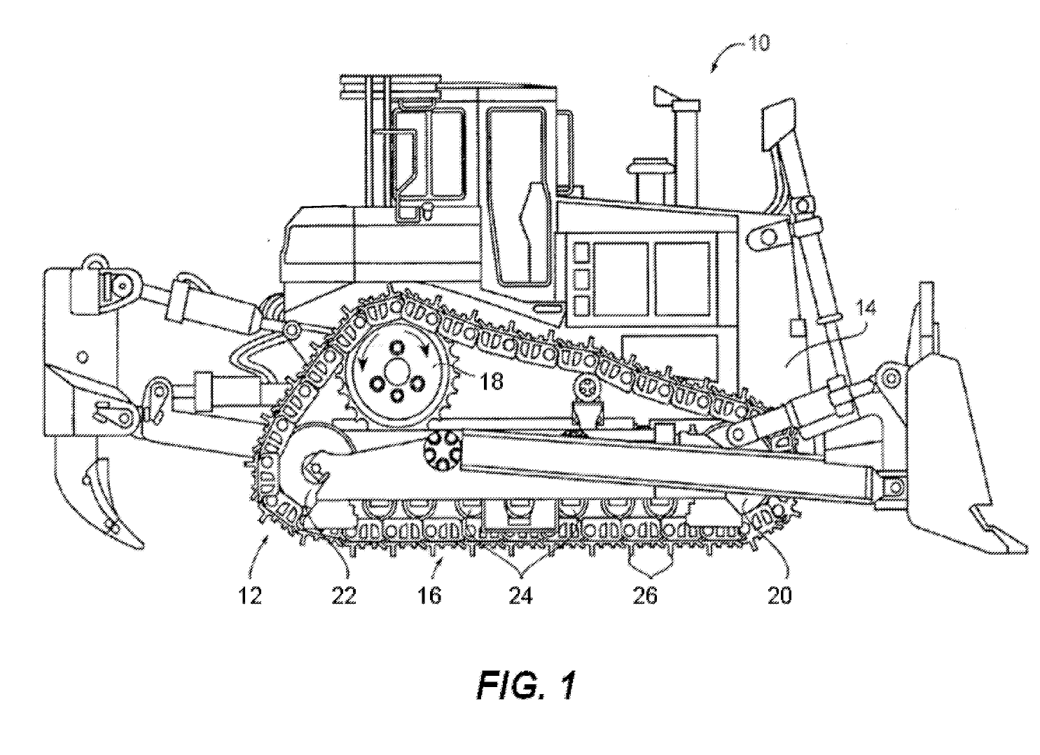

FIG. 1 shows an exemplary embodiment of a machine 10 having a track-type undercarriage 12. The machine 10 may also be referenced herein as a track-type machine. In different embodiments, the machine 10 may be a dozer, loader, or excavator, or any other on-highway or off-highway vehicle. The machine 10 includes a frame 14 having a first track chain assembly 16 disposed on the right side of the machine 10, and a second track chain assembly (not shown) disposed on the left side of the machine 10. Together, the track assemblies are adapted to engage the ground or other surface to propel the machine 10 over the surface. It should be appreciated that the track chain assemblies 16 of the machine 10 may be similar and, further, may represent mirror images of one another. As such, only the first track chain assembly 16 will be described herein, and it should be understood that the description of the first track chain assembly 16 is applicable to the second track chain assembly, as well.

The first track chain assembly 16 extends about a plurality of rolling elements such as a drive sprocket 18, a front idler 20, a rear idler 22, and a plurality of track rollers 24. The track chain assembly 16 includes a plurality of ground-engaging track shoes 26 for engaging the ground or other surface and propelling the machine 10 over the surface. During typical operation of the undercarriage 12, the drive sprocket 18 is driven in a clockwise rotational direction as shown in FIG. 1 to drive the track chain assembly 16, and thus the machine 10, in a forward direction, and in a counterclockwise rotational direction to drive the track chain assembly 16 and thus the machine 10 in a reverse direction. The drive sprockets 18 of the undercarriage 12 can be independently operated to create a velocity differential that allows the machine 10 to turn. While the machine 10 is illustrated in the context of a track-type machine, it should be appreciated that the present disclosure is not thereby limited, and that a wide variety of other machines having tracks are also contemplated within the present context. For example, in other embodiments, the track chain assembly 16 can be included in a conveyor system as a track for transmitting torque between rotating elements, or in any other application known to those skilled in the art.

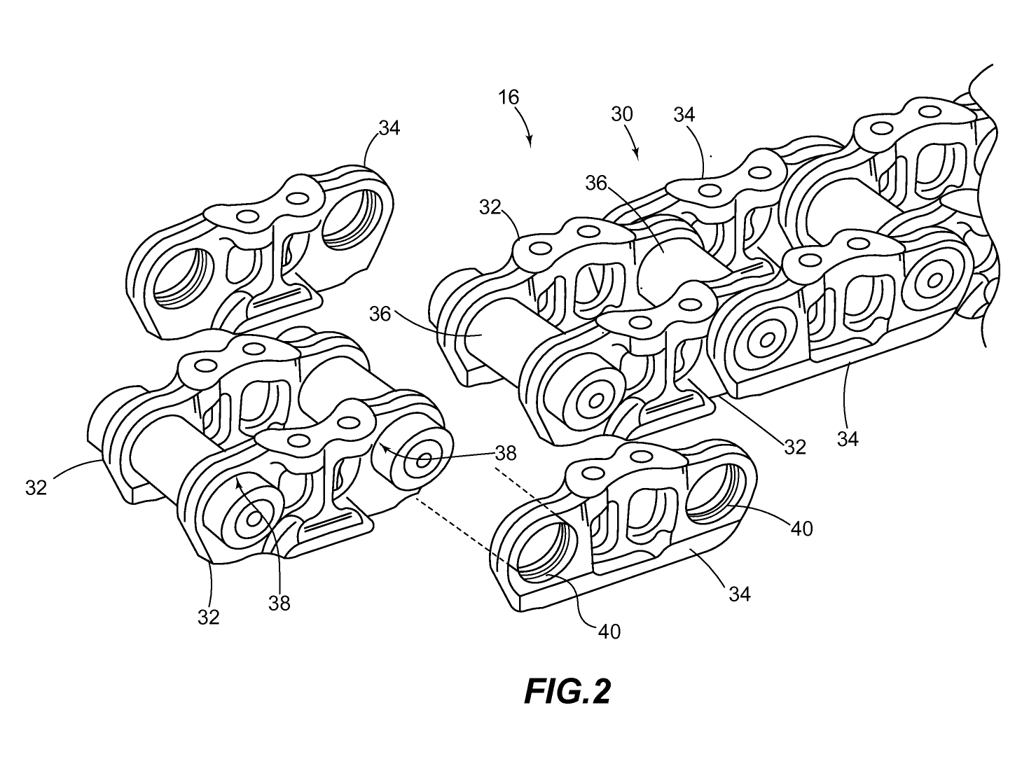

FIG. 2 shows a portion of the track chain assembly 16. The track chain assembly 16 may be composed of a plurality of track chain subassemblies 30. The track chain assembly 16 may be formed by mechanically coupling multiple subassemblies 30 together to form a closed loop. Utilizing a greater number of subassemblies 30 will increase the size of the loop, while removing subassemblies 30 will decrease the size of the loop. Typically, the track chain assembly 16 has a predetermined length for a given application. Each subassembly 30 may include a pair of inner links 32, a pair of outer links 34, and a track pin cartridge 36. The inner links 32 may have a length substantially similar to a length of the outer links 34. Alternatively, the inner links 32 may be either longer or shorter than the outer links 34. Both the inner links 32 and the outer links 34 may be composed of a metallic material, such as steel. Each inner link 32 may include two apertures 38, and each outer link 34 may include two apertures 40. The apertures 38, 40 may be sized and configured to receive the track pin cartridge 36 in a manner discussed further below.

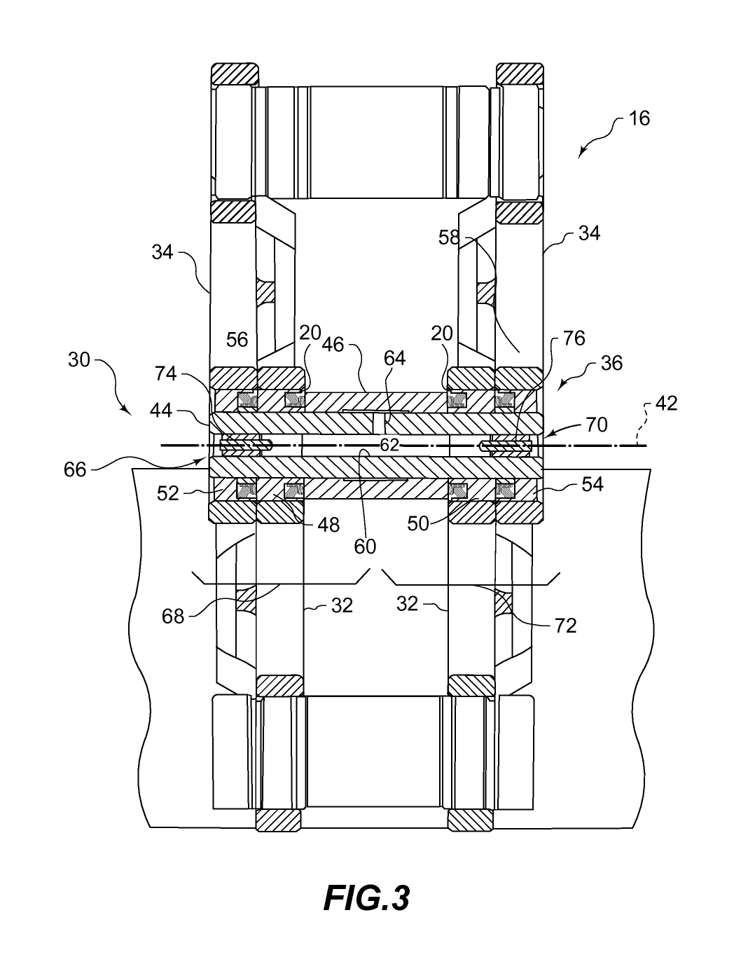

As shown in FIG. 3, the cartridge 36 may be a cross member that connects the inner links 32 and the outer links 34 together. The cartridge 36 may also allow for rotation of the inner links 32 relative to the outer links 34 about a central rotational or longitudinal axis 42. The cartridge 36 may include a track pin 44, a bushing 46, a first bearing 48, a second bearing 50, a first collar 52, a second collar 54, a thrust bearing 56 and a second thrust bearing 58. The track pin 44 includes a bore 60 defining a reservoir 62, and a fluid passageway 64. The bore 60 may be centered on the longitudinal axis 42 within the track pin 44 and may extend along a longitudinal dimension of the track pin 44. The bore 60 may extend completely through the track pin 44, thus defining a first opening 66 at an axially outermost portion of a first end 68. The bore 60 may also define a second opening 70 at an axially outermost portion of a second end 72. The bore 60 may be substantially symmetrical. In one embodiment, the bore 60 may have a circular cross section and be cylindrical in shape. Alternatively, the bore 60 may have a rectangular, polygonal, or any other appropriate cross section.

The first opening 66 may be configured to receive a first stopper 74. The first stopper 74 may have a shape that is complimentary to the cross sectional shape of the bore 60. For example, if the bore 60 is cylindrical, the first stopper 74 may also be cylindrical. If the bore 60 is rectangular, the first stopper 74 may be rectangular. The first stopper 74 may be sized such that it passes entirely within the bore 60. In other words, an outside diameter and a length of the first stopper 74 may be configured such that the first stopper 74 passes into the bore 60 and seals the bore 60 within the first end 68. A second stopper 76 may be substantially the same as the first stopper 74 except that it may be received in the second end 72.

FIG. 3 shows first end 68 of cartridge 36. Since cartridge 36 is substantially symmetrical (i.e., second end 72 is essentially a mirror image of first end 68), only first end 68 is described herein in certain sections. All details provided about the elements of first end 68 apply equally to the complimentary elements of second end 72.

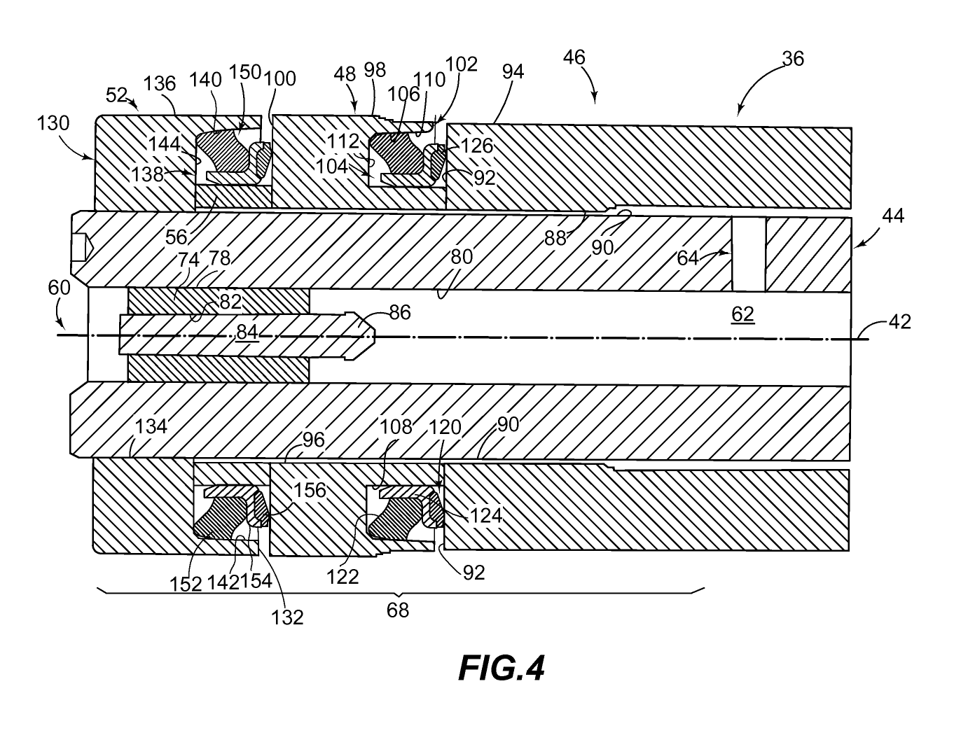

As can be seen in FIG. 4, an outer surface 78 of the stopper 74 may contact an inner surface 80 of the bore 60. Specifically, the outer surface 78 may mate and/or attach to the inner surface 80 via welding, adhesives, interference fit, or in any other appropriate manner known in the art. The stopper 74 may be cylindrical and define a central passageway 82 configured to receive a plug 84. It is contemplated that the plug 84 may be a shaft-like member composed of rubber, plastic, or another compliant or deformable material. The plug 84 may include a nub 86 on one end. The nub 86 may prevent the plug 84 from displacing axially in a direction away from the cartridge 36.

The reservoir 62 may be a fluid reservoir configured to hold lubricating fluid. The reservoir 62 may be defined by the inner surface 80 and inward ends of the stoppers 74, 76. The reservoir 62 may be filled or refilled by removing the plug 84 and introducing lubricating fluid. The fluid passageway 64 may channel fluid from the reservoir 62 to rotatable components of the cartridge 36 (e.g., the first and second bearings 48, 50). The fluid passageway 64 may be a cross bore oriented radially with respect to the longitudinal axis 42. In some embodiments, the track pin 44 may include a plurality of fluid passageways 64 to allow for an increased or more even distribution of lubricating fluid. For example, the track pin 44 may include a fluid passageway 64 every 180 degrees, 90 degrees, 60 degrees or 45 degrees. the fluid passageway 64 may have a substantially cylindrical shape.

The bushing 46 may be a cylindrical or tubular member situated on the track pin 44. The bushing 46 may be axially located in a generally central position with respect to the first end 68 and the second end 72. The bushing 46 may include an inner surface 88 that faces an outer surface 90 of the track pin 44. The bushing 46 may also include side faces 92 and an outer surface 94. The bushing 46 may be sized to produce a clearance space between the inner surface 88 and the outer surface 90. Lubricating fluid may pass through this clearance space along a length of the bushing 46. The bushing 46 may be rotatable with respect to the track pin 44, and the lubricating fluid may facilitate rotation thereof. Alternatively, the bushing 46 may be fixed with respect to the track pin 44 via mechanical fasteners or other appropriate means.

The first bearing 48 may be a rotatable member configured to rotate about the track pin 44. The first bearing 48 includes an inner bore defining an inner surface 96. The inner surface 96 may face the outer surface 90 of the track pin 44. A gap may exist between the inner surface 96 and the outer surface 90, allowing relative rotation between each surface 90, 96. Lubricating fluid may flow into the gap between the inner surface 96 and the outer surface 90, thus reducing any friction between the surfaces 90, 96. The first bearing 48 may connect to the inner link 32 (see FIG. 3). Specifically, the first bearing 48 may include an outer surface 98 that contacts an inner surface of the inner link aperture 38. The first bearing 48 may be secured within the inner link aperture 38 via mechanical fasteners, adhesives, welding, friction fitting, or in any other appropriate manner to prevent relative motion there between. At the same time, the gap between the surfaces 90, 96 may allow the first bearing 48 and, correspondingly, the inner link 32 to rotate relative to the track pin 44 about the longitudinal axis 42.

Referring to FIG. 4, the first bearing 48 may also include a first face 100, a second face 102. The first face 100 extends radially between the inner surface 96 and the outer surface 98 and forms an abutting surface. The first bearing 48 is positioned about the track pin 44 so that the second face 102 of the first bearing 48 is adjacent the corresponding side face 92 of the bushing 46. The second face 102 defines an axially-extending seal cavity 104 in the form of an annular channel or groove. The first bearing 48 includes a first load ring engagement surface 106 defining, at least in part, the axially-extending seal cavity 104. The seal cavity 104 is positioned in the second face 102 such that seal cavity 104 is concentric with the longitudinal axis 42 of the track pin 44.

The second face 102 includes an inner cylindrical axial wall segment 108, an outer cylindrical axial wall segment 110, and a radial base segment 112 extending between the inner and outer cylindrical axial wall segments 108, 110. The inner and outer cylindrical axial wall segments 108, 110 and the radial base segment 112 define the seal cavity 104. The inner and outer cylindrical axial wall segments 108, 110 are concentrically disposed about the longitudinal axis 42.

The load ring engagement surface 106 can include at least part of the outer cylindrical axial wall segment 110 and/or the radial base segment 112. In the illustrated embodiment, the load ring engagement surface 106 includes at least part of both the outer cylindrical axial wall segment 110 and the radial base segment 112. The outer cylindrical axial wall segment 110 may be tapered outwardly with respect to the longitudinal axis 42 at a predetermined angle. In one embodiment, the predetermined angle is about 5°. In a similar manner, the inner cylindrical axial wall segment 108 may be tapered inwardly with respect to the longitudinal axis 42. The inner cylindrical axial wall segment 108 extends axially beyond the outer cylindrical axial wall segment 110 toward the side face 92 of the bushing 46.

The components of the track pin cartridge 36 can define a plurality of annular seal grooves or cavities 104 that are concentrically disposed about the longitudinal axis 42 of the track pin 44. Each seal cavity 104 is adapted to house therein a seal assembly constructed according to principles of the present disclosure and suitable for sealingly engaging relatively rotatable components of the track pin cartridge 36.

For purposes of illustration, the first bearing 48 can be considered a first member, and the bushing 46 can be considered a second member. The first bearing 48 and the bushing 46 are both coaxial with the track pin 44 about the longitudinal axis 42. The first bearing 48 is pivotable with respect to the bushing 46 about the longitudinal axis 42. A first seal assembly 120 constructed in accordance with principles of the present disclosure can be disposed within the seal cavity 104 defined in part by the load ring engagement surface 106 adjacent the second face 102 of the first bearing 48. The axially-extending seal cavity 104 is disposed in proximal relationship to the bushing 46 in this example. The seal assembly 120 sealingly engages the first bearing 48 and the bushing 46 while allowing relative rotation there between.

The first seal assembly 120 includes a load ring 122, a can or seal ring 124, and a seal ring in the form of a sealing lip 126. The load ring 122 may be fabricated from, for example, an elastomeric material, and the sealing lip 126 may be fabricated from a suitable sealing material such as an elastomeric material including a polyurethane compound, for example. The seal ring 124 may be fabricated from any suitable material, such as metal, for example. The components of the seal assembly 120 may be fabricated from other materials in other embodiments without altering the functional aspects of the design.

The load ring 122 and the sealing lip 126 are positioned in the seal cavity 104 so that the load ring 122 acts upon the seal ring 124 to urge the sealing lip 126 in an axial direction along the longitudinal axis 42 from the seal cavity 104 into sealing engagement with the side face 92 of the bushing 46. The sealing lip 126 can rotate with respect to the sealing surface of the side face 92 of the bushing 46 against which it is sealingly engaged. The load ring 122 sealingly engages the load ring engagement surface 106 of the first bearing 48.

The orientation of the outer cylindrical axial wall segment 110 such that it is angled away from the longitudinal axis 42 facilitates the insertion of the first seal assembly 120 into the seal cavity 104. In particular, the predetermined angle of the outer cylindrical axial wall segment 110 enhances the installation capability of the equipment utilized to insert the first seal assembly 120 into the seal cavity 104.

The first collar 52 includes a first face 130, a second face 132, an inner surface 134 that is concentrically disposed about the longitudinal axis 42, and an outer surface 136. The first collar 52 is positioned at one end of the track pin 44 and is press fit with the track pin 44 such that the first collar 52 and the track pin 44 are rotatably coupled together.

The first face 130 extends radially between the inner surface 134 and the outer surface 136 and forms an outer radial surface of the track pin cartridge 36. The second face 132 defines an axially-extending seal cavity 138 in the form of an annular channel or groove. The first collar 52 includes a load ring engagement surface 140 defining, at least in part, the axially-extending seal cavity 138. The seal cavity 138 is positioned in the second face 132 such that seal cavity 138 is concentric with the longitudinal axis 42.

The second face 132 includes an outer cylindrical axial wall segment 142 and a radial base segment 144 extending between the outer cylindrical axial wall segment 142 and the inner surface 134. The first thrust bearing 56 is disposed between the first collar 52 and the first bearing 48 and is adapted to transmit axial loads there between. The first thrust bearing 56 may have an inner surface 146 having an inner diameter that is larger than an outer diameter of the track pin 44 so that the thrust bearing 56 may be rotatable about the longitudinal axis 42. The outer cylindrical axial wall segment 142, the radial base segment 144, and the first thrust bearing 56 define the seal cavity 138. The second thrust bearing 58 is similarly disposed between the second collar 54 and the second bearing 50 and is adapted to transmit axial loads there between.

The seal cavity 138 of the first collar 52 is substantially similar in configuration to the seal cavity 104 of the first bearing 48. For example, the outer cylindrical axial wall segment 142 can be tapered outwardly with respect to the longitudinal axis 42 at a predetermined angle similar to the outer cylindrical axial wall segment 110 of the first bearing 48. In one embodiment, the predetermined angle is about 5°.

The load ring engagement surface 140 can include at least part of the outer cylindrical axial wall segment 142 and/or the radial base segment 144. In the illustrated embodiment, the load ring engagement surface 140 includes at least part of both the outer cylindrical axial wall segment 142 and the radial base segment 144.

A second seal assembly 150 is disposed in the seal cavity 138 defined in part by the load ring engagement surface 140 adjacent the second face 132 of the first collar 52. The seal assembly 150 sealingly engages a first member in the form of the first collar 52 and a second member in the form of the first bearing 48 while allowing relative rotation there between. The second seal assembly 150 includes a load ring 152, a seal ring 154, and a seal ring in the form of a sealing lip 156. The components of the second seal assembly 150 are similar in composition and function to that of the first seal assembly 120 as described above in connection with the seal cavity 104 of the first bearing 48. The load ring 152 and the sealing lip 156 of the second seal assembly 150 are positioned in the seal cavity 138 so that the load ring 152 acts upon the seal ring 154 to urge the sealing lip 156 in an axial direction along the longitudinal axis 42 from the seal cavity 138 into sealing engagement with the first face 100 of the first bearing 48. The sealing lip 156 can rotate with respect to the sealing surface of the first face 100 of the first bearing 48 against which it is sealingly engaged. The load ring 152 sealingly engages the load ring engagement surface 140 of the first collar 52.

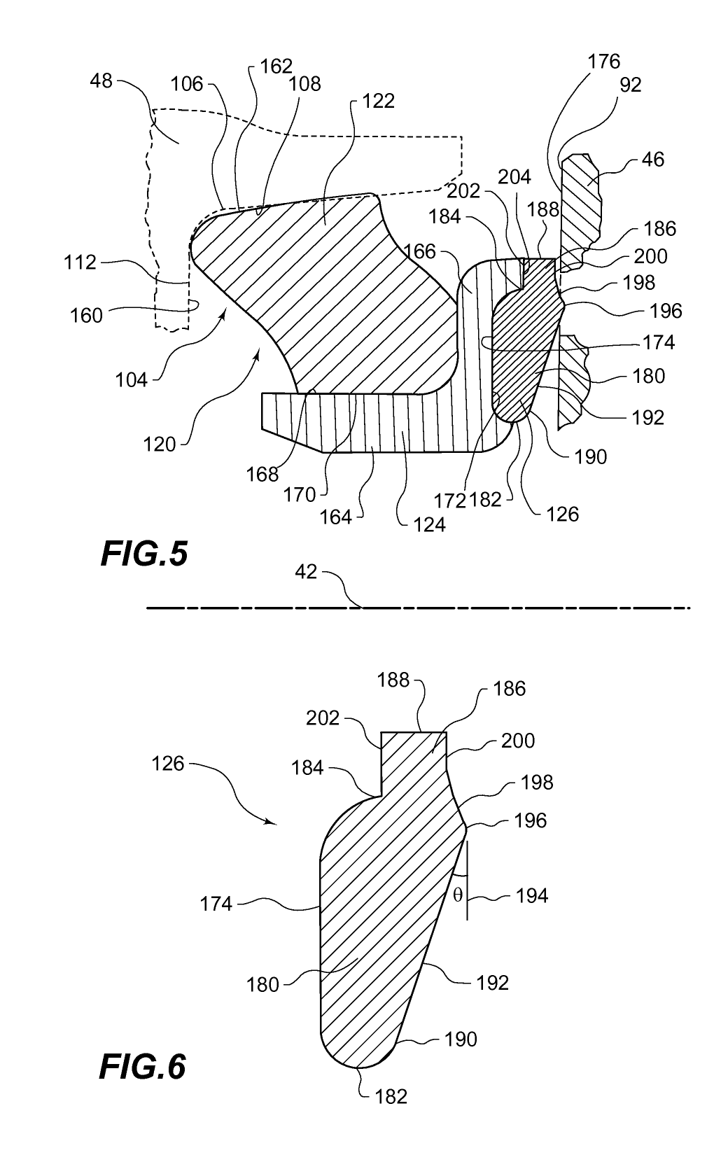

Referring to FIG. 5, the first seal assembly 120, which is constructed in accordance with principles of the present disclosure, is shown in an uninstalled state wherein the components are not compressed between the first bearing 48 and the bushing 46 which are shown in phantom lines. The cross-sectional shapes of the uncompressed components of the first seal assembly 120 are shown. It should be understood that the illustrated components have a substantially similar configuration about their entire circumference such that a cross-sectional view taken through another plane intersecting the center of the seal assembly 120 would be substantially similar. The first seal assembly 120 includes the load ring 122, the can or seal ring 124, and the sealing lip 126 extending axially from the seal ring 124. Inasmuch as the second seal assembly 150 is identical to the first seal assembly 120, it will be understood that the description of the first seal assembly 120 is also applicable to the second seal assembly 150.

The first seal assembly 120 is adapted for use in sealing the joint where the first bearing 48 is pivotable about the rotational or longitudinal axis 42 of the track pin 44 relative to the bushing 46, for example. The first bearing 48 includes the first load ring engagement surface 106 and a base surface 160 of the radial base segment 112 defining, at least in part, the axially-extending seal cavity 104 about the longitudinal axis 42. The load ring engagement surface 106 of FIG. 5 has a generally straight profile. In other embodiments, the load ring engagement surface 106 can have a different shape. The load ring engagement surface 106 of the first bearing 48 sealingly engages a corresponding first member or first bearing engagement surface 162 of the load ring 122.

The inner cylindrical axial wall segment 108 of the first bearing 48 (shown in FIG. 4) also defines the seal cavity 104. In some embodiments, the inner surface can be integrally formed with the load ring engagement surface 106 and the base surface 160 or can be provided by an insert sleeve component, such as by the first thrust bearing 56 as shown in FIG. 4 for the seal cavity 138, for example. In other embodiments, the base surface 160 can be defined by a separate component.

The seal ring 124 is in the form of an annulus. The seal ring 124 has an axial flange 164, extending parallel to the longitudinal axis 42, and a radial flange 166 extending perpendicular to the longitudinal axis 42. A second load ring engagement surface 168 of the seal ring 124 sealingly engages a corresponding seal ring engagement surface 170 of the load ring 122. In the illustrated embodiment, the radial flange 166 defines a concave groove 172 adapted to receive a complimentary-shaped convex seal ring engagement surface 174 of the sealing lip 126 therein. The seal ring 124 can be made from a rigid material and transmit force from the load ring 122 when installed and under compression. In alternative embodiments, the seal ring 124 and the sealing lip 126 may be integrally formed as a unitary structure.

The sealing lip 126 is in the form of an annulus and extends axially from the concave groove 172 of the seal ring 124 along the longitudinal axis 42. The force from the load ring 122 is transferred from the seal ring 124 to the sealing lip 126 to sealingly engage, in a running fluid-tight seal, a sealing surface 176 of the side face 92 of the bushing 46 that is rotationally movable about the longitudinal axis 42 of the track pin 44 with respect to the first bearing 48.

The cross-section of the sealing lip 126 is shown in greater detail in the enlarged view of FIG. 6. The sealing lip 126 may be formed by an annular sealing lip body 180 having an inward end 182 and an outward end 184 disposed radially outwardly from the inward end 128 relative to the longitudinal axis 42, and integrally formed annular sealing lip flange 186 extending radially outwardly from the outward end 184 of the sealing lip body 180. The inward end 182 may define the outer extent of a circular opening through the sealing lip 126, and an outward surface 188 of the sealing lip flange 186 may define an outer extent of the sealing lip 126.

The convex engagement surface 174 and an oppositely disposed second member or bushing engagement surface 190 may extend radially outwardly from the inward end 182 on either side of the sealing lip body 180. The bushing engagement surface 190 may have an inner angled portion 192 extending from the inward end 182 at an angle relative to a radial line 194 so that a thickness of the sealing lip body 180 increases as the sealing lip body 180 extends away from the longitudinal axis 42. The inner angled portion 192 may form an angle 0 with respect to the radial line 194 within a range of 15°-25°, and some embodiments the angle θ may be approximately 20°.

As the inner angled portion 192 extends toward the outward end 184 of the sealing lip body 180, the bushing engagement surface 190 may transition into a convex engagement portion 196. The convex engagement portion 196 may turn the bushing engagement surface 190 back toward the convex engagement surface 174 on the opposite side of the sealing lip body 180. The convex engagement portion 196 may turn about a constant radius of curvature and describe a circular arc, or may have a parabolic or other type of non-circular curvature describing a non-circular rounded surface having a varying radius of curvature.

Outward of the convex engagement portion 196, the bushing engagement surface 190 may transition to a transition portion 198 having a concave curvature. The concave transition portion 198 extends away from the convex engagement portion 196 until it intersects a sealing side radial surface 200 of the sealing lip flange 186 that extends to and intersects with the outward surface 188. The sealing side radial surface 200 may be substantially perpendicular to the longitudinal axis 42, or may be angled away from the bushing engagement surface 190 at an angle with respect to a line perpendicular to the longitudinal axis 42 in the range of 0°-5°. In this configuration, the sealing side radial surface 200 is offset axially from the outermost extent of the convex engagement portion 196 that will first come into contact with the sealing surface 176 of the side face 92. The sealing lip flange 186 may also have a non-sealing side radial surface 202 extending radially from the outward end 184 of the sealing lip body 180 to the outward surface 188. When the convex engagement surface 174 is received in the concave groove 172 of the seal ring 124 as shown in FIG. 5, the non-sealing side radial surface 202 of the sealing lip flange 186 may be disposed against an outward radial surface 204 of the radial flange 166 of the seal ring 124.

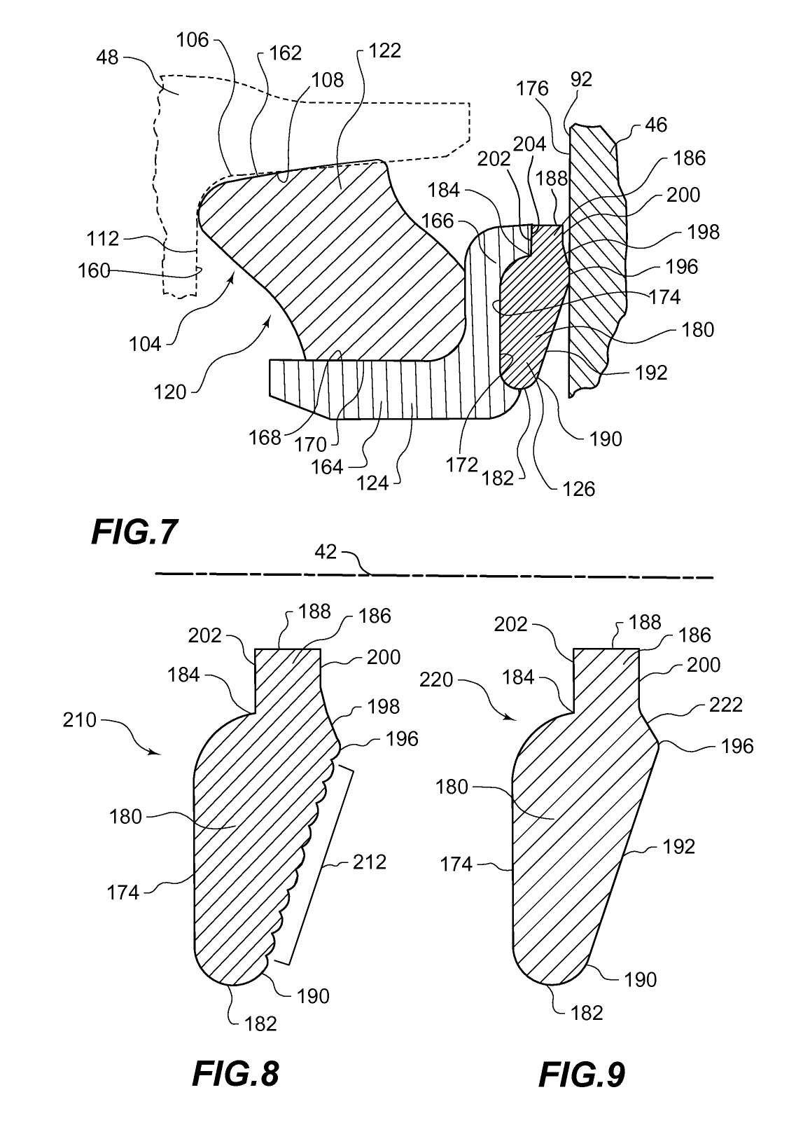

FIG. 7 illustrates the first seal assembly 120 installed in the seal cavity 104 between the first load ring engagement surface 106 of the first bearing 48 and the sealing surface 176 on the side face 92 of the bushing 46. The convex engagement surface 174 compresses the bushing engagement surface 190 at the convex engagement portion 196 and adjoining areas of the inner angled portion 192 and the concave transition portion 198 to form a seal preventing lubricant from escaping and material from entering the track pin cartridge 36. Due to the compression of the bushing engagement surface 190, the sealing side radial surface 200 of the sealing lip flange 186 is disposed adjacent and in close proximity to the sealing surface 176. In some embodiments, the sealing side radial surface 200 may come into contact with the sealing surface 176 as will be illustrated and discussed further below. A normal force between the surfaces 176, 200 will be substantially less than a normal force between the convex engagement portion 196 and the sealing surface 176, thereby minimizing the wear of material there between. The proximity of the surfaces 176, 200 when the seal assembly 120 is installed provides an additional barrier further minimizing the amount of dirt, sand and other abrasive materials reaching the interface between the sealing lip 126 and the side face 92 of the bushing 46.

FIGS. 8 and 9 illustrate alternative cross-section sectional configurations of the sealing lip 126. In FIG. 8, a first alternative embodiment of a sealing lip 210 has a generally similar configuration as the sealing lip 126, but with the inner angled portion 192 of the bushing engagement surface 190 being replaced by a series of additional convex engagement portions 212 between the inward end 182 of the sealing lip body 180 and the convex engagement portion 196. A first of the additional convex engagement portions 212 may be disposed adjacent the first convex engagement portions 196 and radially closer to the longitudinal axis 42 and axially closer to the convex engagement surface 174. Each remaining or subsequent convex engagement portion 212 may have a similar relationship with the adjacent convex engagement portions 212.

The additional engagement portion(s) 212 may provide a secondary seal that may be formed after a period of time to extend the useful life of the track pin cartridge 36. As discussed above, a groove may wear into the side face 92 of the bushing 46 as the sealing surface 176 was relative to the sealing lip 126. The convex engagement portion 196 may reduce groove formation vis-à-vis prior sealing lips with sharper engagement portions, but grooves may still form after thousands of hours of operation. As the groove forms or material wears away from the convex engagement portion 196, the sealing lip 126 can move axially toward the sealing surface 176 due to the force exerted by the compressed load ring 122 through the seal ring 124 to the sealing lip 126. Eventually, the first additional convex engagement portion 212 inward from the convex engagement portion 196 will come in the contact with the sealing surface 176 to increase the size of the seal and further distribute the normal force between the sealing lip 126 and the sealing surface 176 of the side face 92, thereby slowing the rate of wear. If the track pin cartridge 36 continues in-service, for the wear of material that the seal will result in the subsequent convex engagement portions 212 contacting the sealing surface 176 until the track pin cartridge 36 is replaced.

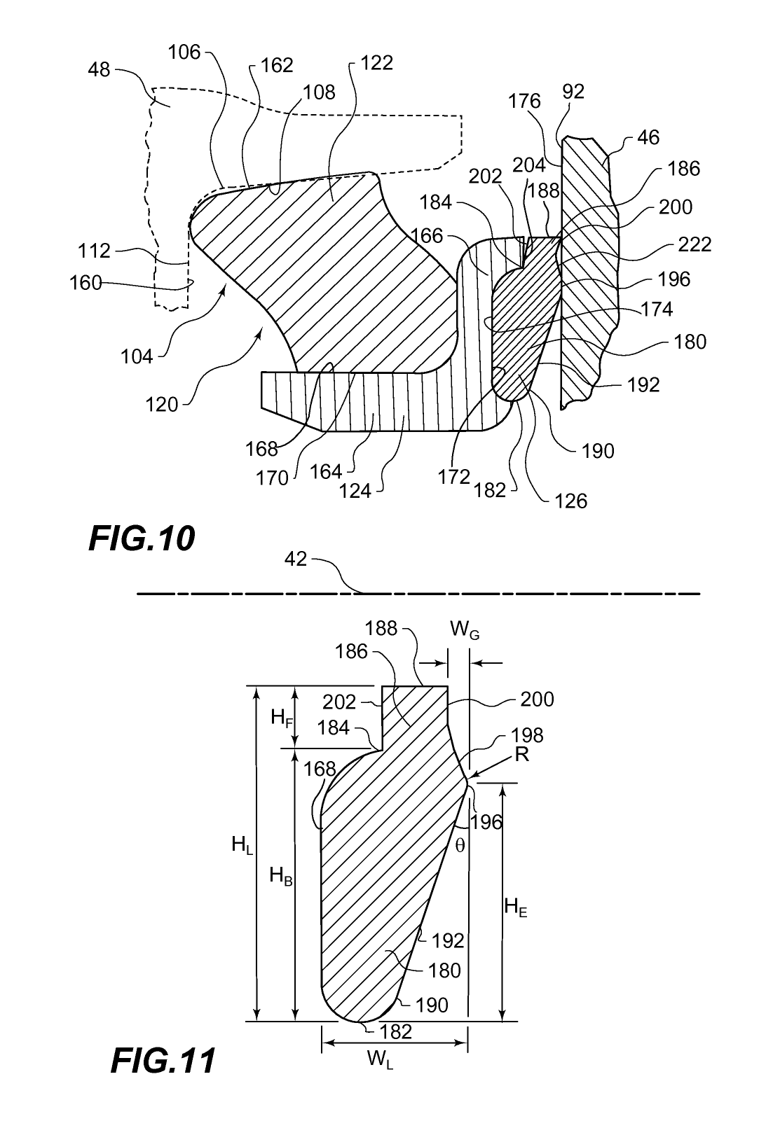

FIG. 9 illustrates a further alternative embodiment of a sealing lip 220 wherein the sealing lip flange 186 is more clearly delineated from the sealing lip body 180 on the sealing side of the sealing lip 126. In the sealing lip 220, the sealing side radial surface 200 may extend from the outward and 184 of the sealing lip body 180 to the outward surface 188 and be intersected at the outward end 184 by a transition portion 222 of the bushing engagement surface 190. The transition portion 222 may be a linear transition portion 222 as shown, convex similar to the transition portion 198, or have any other appropriate shape for the transition. With this configuration, the sealing lip flange 186 may provide increased protection of the seal formed by the seal assembly 120 from encroachment by abrasive materials. As shown in FIG. 10, the point of engagement and compression of the sealing lip body 180 against the sealing surface 176 is inward of the outward end 184 of the sealing lip body 180 and the outward radial surface 204 facing the non-sealing side radial surface 202 of the sealing lip flange 186. This offset and forces acting in opposite directions on the sealing lip body 180 and the sealing lip flange 186 may cause a bending moment sufficient to cause the sealing lip flange 186 to deflect toward the sealing surface 176. The sealing lip flange 186 may be deflected sufficiently to close the gap with the sealing surface 176 so that it is engaged by the point at which the surfaces 188, 200 intersect. The closure between the sealing lip flange 186 and the sealing surface 176 may substantially prevent abrasive materials from reaching the seal between the convex engagement portion 196 of the bushing engagement surface 190 and the sealing surface 176. Those skilled in the art will understand that a similar deflection may occur by the sealing lip flange 186 of the sealing lips 126, 210 depending on the properties of the materials used in forming the sealing lips 126, 210.

### INDUSTRIAL APPLICABILITY

Seal assemblies with sealing lips in accordance with the present disclosure can extend the useful lives of the track pin cartridges 36 in which they are installed. The configuration of the bushing engagement surface 190 reduces the rate of wear of material at the point that the seal is formed between the bushing engagement surface 190 and the sealing surface 176 of the side face 92 of the bushing 46. The convex engagement portion 196 of the bushing engagement surface 190 does not gouge the sealing surface 176 as severely as previously known sealing lips having sharp edges engaging the sealing surface 176 at a point contact or line of contact. The convex engagement portion 196 of the sealing lip 126 should slow the formation of grooves in the sealing surface 176 that reduce the sealing force between the sealing lip 126 and the sealing surface 176 over time and ultimately compromise the seal and the track pin cartridge 36.

The wear rate in the seal assemblies 120, 150 is further reduced by the addition of the sealing lip flange 186 that shields the seal from encroachment by abrasive materials in a way not provided in prior seal assemblies. With the sealing side radial surface 200 disposed adjacent the sealing surface 176, and in some embodiments engaging the sealing surface 176, the sealing lip 126 minimizes the opportunity for dirt, mud, sand and other abrasive materials to reach the seal between the sealing lip 126 and the sealing surface 176. By fending off the abrasive materials, the seal is protected from increased wear rates and premature failure. Additionally, the likelihood of the abrasive materials traversing the seal and reaching and causing increased wear of the internal components of the track pin cartridge 36 is reduced or eliminated. Consequently, the sealing lip flange 186 further extends the useful life of the track pin cartridge 36. The usefully life may be further extended in the embodiment of the sealing lip 210 of FIG. 8 wherein the additional convex engagement surface(s) 212 engage the sealing surface 176 as a groove forms in the sealing surface 176 and material of the primary convex engagement portion 196 wears away to reinforce the seal.

FIG. 11 illustrates the cross-section of the sealing lip 126 with indications of various dimensions that may be relevant in the design of the sealing lip 126 to provide a desired sealing force when the seal assembly 120 is installed in the track pin cartridge 36. The sealing lip 126 may have an overall sealing lip height H_{L} that may be the sum of a sealing lip body height H_{B} that is a radial distance from the inward end 182 to the outward end 184 of the sealing lip body 180 and a sealing lip flange height H_{F} that is a radial distance from the outward end 184 of the sealing lip body 180 to the outward surface 188 of the sealing lip flange 186. The sealing lip 126 may also have a sealing lip engagement height H_{E} that is a radial distance from the inward end 182 of the sealing lip body 180 to a point of initial contact of the convex engagement portion 196 of the bushing engagement surface 190 with the sealing surface 176 of the side face 92 of the bushing 46. A sealing lip width W_{L} of the sealing lip 126 may be a maximum axial distance from the convex engagement surface 174 of the sealing lip body 180 to the convex engagement portion 196, and a sealing lip gap width W_{G} may be a maximum axial distance from the sealing side radial surface 200 of the sealing lip flange 186 to the convex engagement portion 196. As described above in relation to FIG. 6, the angle θ represents the amount of incline of the inner angled portion 192 of the from a radial line perpendicular to the longitudinal axis 42. A convex engagement portion radius R represents a radius of an arc swept by the convex engagement portion 196 when the portion 196 has a rounded configuration.

In one exemplary embodiment, the sealing lip 126 may have the following approximate dimensions:

| Dimension | Value |
|---|---|
| sealing lip height H_{L} | 5.0 mm (0.1969 inch) |
| sealing lip body height H_{B} | 4.0 mm (0.1575 inch) |
| sealing lip flange height H_{F} | 1.0 mm (0.03937 inch) |
| sealing lip engagement height H_{E} | 3.3 mm (0.1299 inch) |
| sealing lip width W_{L} | 2.4 mm (0.09449 inch) |
| sealing lip gap width W_{G} | 0.5 mm (0.01969 inch) |
| angle θ | 20° ± 5° |
| convex engagement portion radius R | 0.4 mm (0.01575 inch) |

Though not shown in FIG. 11, the sealing side radial surface 200 may be substantially perpendicular to the longitudinal axis 42, or may be angled away from the bushing engagement surface 190 at an angle with respect to a line perpendicular to the longitudinal axis 42 in the range of 0°-5° as discussed above in relation to FIG. 6. It will be apparent that the sealing lip gap width W_{G} will be reduced when the convex engagement portion 196 is compressed by the sealing surface 176 during installation of the seal assembly 120 as shown in FIG. 7. In this embodiment, the sealing width gap W_{G} may decrease approximately 40%-60% of the distance in the range of 0.2 mm (0.007874 inch)-0.3 mm (0.01181 inch) to prevent larger particles of abrasive materials from reaching and affecting the seal.

While the preceding text sets forth a detailed description of numerous different embodiments, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

What is claimed is:

1. A seal assembly for use in sealing a joint having a first member pivotable about a rotational axis relative to a second member thereof, the first member including a first load ring engagement surface defining an axially-extending seal cavity about the rotational axis, and the second member including a sealing surface, the seal assembly comprising:
a load ring having a first member engagement surface that is complimentary to the first load ring engagement surface, and a seal ring engagement surface;
a seal ring having an axial flange extending parallel to the rotational axis, a radial flange extending perpendicular to the rotational axis, a second load ring engagement surface, and a concave groove in the radial flange; and
a sealing lip having a sealing lip body with a convex seal ring engagement surface with a complimentary shape to the concave groove for receipt therein, and a second member engagement surface having a first convex rounded engagement portion positioned to engage the sealing surface of the second member when the seal assembly is assembled in the axially-extending seal cavity between the first member and the second member.

2. The seal assembly according to claim 1, wherein the first convex rounded engagement portion of the second member engagement surface defines a circular arc having a constant radius of curvature.

3. The seal assembly according to claim 1, wherein the first convex rounded engagement portion of the second member engagement surface defines a non-circular rounded surface having a varying radius of curvature.

4. The seal assembly according to claim 1, wherein the second member engagement surface includes a second convex rounded engagement portion positioned adjacent the first convex rounded engagement portion and radially closer to the rotational axis and axially closer to the convex seal ring engagement surface.

5. The seal assembly according to claim 1, wherein the second member engagement surface includes a plurality of second convex rounded engagement portions positioned adjacent the first convex rounded engagement portion, with a first one of the plurality of second convex rounded engagement portions positioned adjacent the first convex rounded engagement portion and radially closer to the rotational axis and axially closer to the convex seal ring engagement surface, and with each of the remaining of the plurality of second convex rounded engagement portions being positioned radially closer to the rotational axis and axially closer to the convex seal ring engagement surface than an adjacent one of the plurality of second convex rounded engagement portions.

6. The seal assembly according to claim 1, wherein the sealing lip comprises a sealing lip flange extending radially outwardly from an outward end of the sealing lip body and having a sealing side radial surface positioned axially closer to the convex seal ring engagement surface than the first convex rounded engagement portion of the second member engagement surface, and wherein the sealing side radial surface is disposed adjacent to and facing the sealing surface when the seal assembly is assembled in the axially-extending seal cavity between the first member and the second member.

7. The seal assembly according to claim 6, wherein the sealing side radial surface deflects toward and engages the sealing surface when the seal assembly is assembled in the axially-extending seal cavity between the first member and the second member.

8. The seal assembly according to claim 7, wherein the radial flange of the seal ring comprises an outward radial surface engaging the sealing lip flange to deflect the sealing lip flange toward and into engagement with the sealing surface when the seal assembly is assembled in the axially-extending seal cavity between the first member and the second member.

9. A sealing lip for a seal assembly for use in sealing a joint having a first member pivotable about a rotational axis relative to a second member thereof, the first member including a first load ring engagement surface defining an axially-extending seal cavity about the rotational axis, and the second member including a sealing surface, wherein the seal assembly includes a load ring having a first member engagement surface that is complimentary to the first load ring engagement surface, and a seal ring engagement surface, and a seal ring having an axial flange extending parallel to the rotational axis, a radial flange extending perpendicular to the rotational axis, a second load ring engagement surface, and a concave groove in the radial flange, the sealing lip comprising:
a sealing lip body having an inward end, an oppositely disposed outward end positioned radially outward of the inward end, a convex seal ring engagement surface with a complimentary shape to the concave groove for receipt therein, and a second member engagement surface having a first engagement portion positioned to engage the sealing surface of the second member when the seal assembly is assembled in the axially-extending seal cavity between the first member and the second member; and
a sealing lip flange extending radially outwardly from an outward end of the sealing lip body and having a sealing side radial surface positioned axially closer to the convex seal ring engagement surface than the first engagement portion of the second member engagement surface, and wherein the sealing side radial surface is disposed adjacent to and facing the sealing surface when the seal assembly is assembled in the axially-extending seal cavity between the first member and the second member.

10. The sealing lip according to claim 9, wherein the sealing side radial surface deflects toward and engages the sealing surface when the seal assembly is assembled in the axially-extending seal cavity between the first member and the second member.

11. The sealing lip according to claim 10, wherein the radial flange of the seal ring includes an outward radial surface, and wherein the sealing lip flange is engaged by the outward radial surface and deflected toward and into engagement with the sealing surface when the seal assembly is assembled in the axially-extending seal cavity between the first member and the second member.

12. The sealing lip according to claim 9, wherein the first engagement portion comprises a first convex rounded engagement portion, and wherein the second member engagement surface comprises a transition portion extending from the first convex rounded engagement portion to the sealing side radial surface of the sealing lip flange.

13. The sealing lip according to claim 12, wherein the transition portion comprises a concave transition portion.

14. The sealing lip according to claim 12, wherein the transition portion comprises a linear transition portion.

15. The sealing lip according to claim 9, wherein the first engagement portion comprises a first convex rounded engagement portion, and wherein the second member engagement surface of the sealing lip body includes a second convex rounded engagement portion positioned adjacent the first convex rounded engagement portion and radially closer to the rotational axis and axially closer to the convex seal ring engagement surface.

16. The seal assembly according to claim 9, wherein the first engagement portion comprises a first convex rounded engagement portion, and wherein the second member engagement surface includes a plurality of second convex rounded engagement portions positioned adjacent the first convex rounded engagement portion, with a first one of the plurality of second convex rounded engagement portions positioned adjacent the first convex rounded engagement portion and radially closer to the rotational axis and axially closer to the convex seal ring engagement surface, and with each of the remaining of the plurality of second convex rounded engagement portions being positioned radially closer to the rotational axis and axially closer to the convex seal ring engagement surface than an adjacent one of the plurality of second convex rounded engagement portions.

17. A seal assembly for use in sealing a joint having a first member pivotable about a rotational axis relative to a second member thereof, the first member including a first load ring engagement surface defining an axially-extending seal cavity about the rotational axis, and the second member including a sealing surface, the seal assembly comprising:
a load ring having a first member engagement surface that is complimentary to the first load ring engagement surface, and a seal ring engagement surface;
a seal ring having an axial flange extending parallel to the rotational axis, a radial flange extending perpendicular to the rotational axis, a second load ring engagement surface, and a concave groove in the radial flange; and
a sealing lip having a sealing lip body with a convex seal ring engagement surface with a complimentary shape to the concave groove for receipt therein, and a second member engagement surface having a first engagement portion positioned to engage the sealing surface of the second member when the seal assembly is assembled in the axially-extending seal cavity between the first member and the second member, and a second engagement portion that is convex and rounded, and positioned adjacent the first engagement portion and radially closer to the rotational axis and axially closer to the convex seal ring engagement surface.

18. The seal assembly according to claim 17, wherein the second member engagement surface includes a third engagement portion that is convex and rounded, and positioned adjacent the second engagement portion and radially closer to the rotational axis and axially closer to the convex seal ring engagement surface.

19. The seal assembly according to claim 17, wherein the sealing lip comprises a sealing lip flange extending radially outwardly from an outward end of the sealing lip body and having a sealing side radial surface positioned axially closer to the convex seal ring engagement surface than the first engagement portion of the second member engagement surface, and wherein the sealing side radial surface is disposed adjacent to and facing the sealing surface when the seal assembly is assembled in the axially-extending seal cavity between the first member and the second member.

20. The seal assembly according to claim 17, wherein the first engagement portion of the second member engagement surface is convex and rounded.
